(19) United States
(12) Patent Application Publication
(10) Pub. No.: US 2013/0068613 A1
(43) Pub. Date: Mar. 21, 2013

(54) AMORPHOUS TRANSITION METAL SULPHIDE FILMS OR SOLIDS AS EFFICIENT ELECTROCATALYSTS FOR HYDROGEN PRODUCTION FROM WATER OR AQUEOUS SOLUTIONS

(71) Applicants: Xile Hu, Lausanne (CH); Daniel Merki, Lausanne (CH); Heron Vrubel, Lausanne (CH)

(72) Inventors: Xile Hu, Lausanne (CH); Daniel Merki, Lausanne (CH); Heron Vrubel, Lausanne (CH)

(73) Assignee: ECOLE POLYTECHNIQUE FEDERALE DE LAUSANNE (EPFL), Lausanne (CH)

(21) Appl. No.: 13/641,276

(22) PCT Filed: Mar. 31, 2011
(86) PCT No.: PCT/EP2011/055026

§ 371 Date: Dec. 5, 2012

(30) Foreign Application Priority Data
Apr. 16, 2010 (EP) 10160119.3

(51) Int. Cl. C25B 11/04; B01J 27/047; B01J 27/051

(52) U.S. Cl. CPC C25B 11/0447; C25B 11/0405; C25B 11/0415; C25B 11/0421; B01J 27/0515; B01J 27/047; B01J 27/051
USPC 204/290.13; 204/290.01; 204/290.15; 204/290.12; 423/561.1; 502/216; 502/222

(57) ABSTRACT

The present invention relates to amorphous transition metal sulphides as electrocatalysts for hydrogen production from water or aqueous solutions and use thereof in electrodes and electrolysers.

### FIELD OF THE INVENTION

The present invention relates to amorphous transition metal sulphides as electrocatalysts for hydrogen production from water or aqueous solutions and use thereof in electrodes and electrolysers.

### BACKGROUND OF THE INVENTION

Hydrogen is proposed as the primary energy carrier for the future world. The benefits of hydrogen economy can be maximized if hydrogen is produced from an appropriate source. Currently the mass production of hydrogen is done by steam-reforming of methane and other fossil fuels. In the absence of carbon capture and sequestration, this technology gives only a marginal improvement in carbon emissions. The most desirable source of hydrogen is water, as it contains no carbon and is abundantly available. Water is also the end product for the recombination reaction of hydrogen and oxygen, during which the energy of these fuels is released. The production of hydrogen and oxygen from water, or the “water splitting”, consists of two half cell reactions (Scheme 1).

H₂O→H₂+0.5O₂ (1)

2H⁺+2e→H₂ (2)

OH⁻→0.5O₂+H⁺+2e (3)

### Scheme 1. Water Splitting and its Two Half Reactions

In order to achieve high efficiency in water splitting, catalysts are needed for the reduction of proton to form H₂. Indeed the hydrogen evolution reaction (equation 2 in Scheme 1), that is, the reduction of proton to form H₂, is the key component for water electrolysis. It requires active catalysts. Pt and Pt metal composites catalyze hydrogen evolution efficiently at nearly zero overpotential (η) in acidic conditions (overpotential is the difference between the operating potential and the thermodynamic potential). However, the large scale application of Pt catalysts is limited by their high cost (Pt is sold for more than 1000 US Dollar per 28.3 g; for comparison, Ni is sold for 10 US dollars per 453 g), low abundance, and intolerance to impurities such as carbon monoxide. Ni based metal oxides and alloys work in alkaline conditions. Their use is limited by hash reaction conditions and the requirement for isolation to exclude CO₂. Extensive efforts have been devoted to the search of alternative catalysts containing only non-precious elements under both homogeneous and heterogeneous conditions.

Recently, MoS₂ nanoparticles have been identified as hydrogen evolution catalysts (Science, 2007, 317, 100; and Journal of the American Chemical Society, 2005, 127, 5308). Bulk MoS₂ is a poor catalyst, whereas nano-particules of MoS₂ and related metal sulfides, however, are more active. The best catalysts were crystallized, single-layered MoS₂ polygons deposited on Au(111), whith on-set η at 100-150 mV. Notwithstanding the impressive advances, the practical implementation of these systems is hindered by their sophisticated and/or energy intensive preparation procedures, such as ultra-high vacuum conditions, reduction by H₂S streams and annealing at elevated temperatures. Crystalline particules of WS₂ are also known as hydrogen evolution catalysts (J. Phys. Chem., 1988, 92, 2311).

A method for obtaining electrochemical deposited amorphous MoS₂ thin films is disclosed in Thin Solid Films, 1996, 280, p. 86-89 and Thin Solid Films, 2006, 496, p. 293-298. However the disclosed amorphous MoS₂ thin films do not have specific applications and are simply used as intermediate products; the final product being obtained after annealing of amorphous MoS₂ thin films. The final product is used for solar cell, lubrication applications or as hydrodesulphurization catalysts.

Amorphous molybdenum/tungsten sulfides doped with ternary metal, such as Ni or Co, were disclosed in U.S. Pat. No. 5,872,073 (Shane J. Hilsenbeck et al.) as effective hydrodesulphurization (HDS) catalyst both as-prepared and after a variety of pretreatment conditions.

Thus there is still a need to find catalysts which can efficiently catalyze hydrogen production from water, which consist in non-precious metals, which can operate at low overpotential in water or aqueous solutions, under mild conditions, and with reasonable current densities and which can be simply and rapidly produced.

Surprisingly the Applicants were able to solve this problem in the present invention by providing an electrocatalyst having unique catalytic properties.

### SUMMARY OF THE INVENTION

The invention relates to the use of amorphous transition metal sulphide films or solids as electrocatalysts for the reduction of proton to form H₂, which may be further doped with at least one metal selected from the group comprising Ni, Co, Mn, Cu, Fe.

The invention further relates to the use of amorphous transition metal sulphide films or solids, wherein said amorphous transition metal sulphide films or solids are further doped with at least one metal selected from the group comprising Mn, Fe, Ni, Co, Cu, Zn, Sc, Ti, V, Cr, and Y.

The invention further encompasses electrode for use in the production of hydrogen gas from water or aqueous solutions comprising an electrode substrate, wherein the amorphous transition metal sulphide films or solids of the present invention are deposited on said electrode substrate. Preferably said amorphous transition metal sulphide films or solids are selected from the group comprising amorphous MoS₂ film or solid, amorphous MoS₃ film or solid, amorphous WS₂ film or solid, and amorphous WS₃ film or solid and preferably the electrode substrate is any conducting or semi-conducting substrate, selected from the group comprising glassy carbon disc, reticulated vitreous carbon foam, FTO coated glass, indium tin oxide, carbon fiber, carbon nanotube, carbon clothes, graphene, Si, Cu2O, TiO2, titanium metal, and boron-doped diamond.

The invention also relates to electrolysers for the hydrolysis of water or aqueous solutions comprising the electrode of the invention.

Additionally the invention provides a method for preparing amorphous MoS₃ solids comprising the steps of:
a) dissolving molybdenum trioxide (MoS₃) in an aqueous solution of sodium sulphide,
b) acidifying the solution of step a),
c) recovering the obtained amorphous MoS₃ solids

### BRIEF DESCRIPTION OF FIGURES

FIG. 1 shows deposition of MoS₃-DM film on a FTO coated glass by repeating cyclic voltammetry (25 cycles) with a solution of [MoS₄]²⁻ in water. The arrows point to the growth of peaks during the deposition.

FIG. 2 shows XPS spectra of MoS₃-DM film on a FTO coated glass. (A) Mo 3d and S is region. (B) S 2p region.

FIG. 3 shows thickness of MoS₃-DM films on FTO as a function of scanning cycles and concentration of precursors. The measurements have been repeated multiple times to give the averaged values and error bars. (A) Thickness of MoS₃-DM films as a function of scanning cycles; the concentration of MoS₄²⁻ is 2.0 mM. (B) Thickness of MoS₃-DM films as a function of MoS₄²⁻ concentrations; 25 scanning cycles were applied for each deposition.

FIG. 4 shows (A) XPS Mo spectrum of the MoS₃—B film. (B) XPS S spectrum of the MoS₃—B film. (C) XPS Mo spectrum of the MoS₂-LC film. (D) XPS S spectrum of the MoS₂-LC film.

FIG. 5 shows UV-vis absorption spectra of the freshly prepared MoSₓ films: MoS₃-DM, MoS₂-DM, MoS₃—B, and MoS₂-LC.

FIG. 6 shows polarization curves of MoS₃-DM film on a rotating glassy carbon disk electrode recorded at pH=0, 1, 2, and 5. Scan rate: 2 mV/s; rotating rate: 4500 rpm.

FIG. 7 shows (A) Polarization curves of MoS₃-DM film on a rotating glassy carbon electrode recorded at pH=7, 9, 11, and 13. Scan rate: 2 mV/s; rotating rate: 4500 rpm. (B) Polarization curves of MoS₃-DM film on FTO recorded at pH=2. Scan rate: 2 mV/s

FIG. 8 shows polarization curves of MoSₓ-films on FTO recorded at pH=0, Scan rate: 2 mV/s. The curves are from the second polarization scans for the freshly prepared samples, some of which need a pre-activation process in the first polarization scan (see main text for details).

FIG. 9 shows consecutive polarization curves of MoSₓ films on FTO at pH=0: MoS₃—B (A), MoS₃-DM (B), MoS₂-DM (C), and MoS₂-LC (D).

FIG. 10 shows first polarization curves of freshly prepared MoSₓ films on FTO at pH=0. The arrows point to the reduction prior to hydrogen evolution.

FIG. 11 shows (A) XPS Mo spectrum of the MoS₃-DM film after 10 polarization measurement at pH=0. (B) XPS S spectrum of the MoS₃-DM film after 10 polarization measurement at pH=0.

FIG. 12 shows Tafel analysis of the polarization curve at η=170 to 200 mV for MoS₃-DM film on glassy carbon at pH=0. The film was made with 25 scanning cycles. Scan rate for polarization: 1 mV/s.

FIG. 13 shows current efficiency for H₂ production catalyzed by a MoS₃-DM film on glassy carbon at pH=0 and 200 mV overpotential. The theoretical line was calculated according to the cumulative charge, assuming a 100% Faraday's yield for H₂ production. The current density was ca. 14 mA/cm².

FIG. 14 shows cell used for electrolysis experiments. (A) Insert on the Luggin capillary for the reference electrode, (B) 6 mm diameter glassy carbon working electrode, (C) Platinum wire counter electrode, (D) Septum closed inlet, (E) PVC tubing connecting the cell to the pressure meter.

FIG. 15 shows consecutive polarization curves at pH 2 of films deposited in presence of different first row transition metal ions; scan rate=2 mV/s.

FIG. 16 shows consecutive polarization curves at pH 0 of films deposited in presence of different first row transition metal ions; scan rate=2 mV/s.

FIG. 17 shows polarization curves at pH 0 (left) and pH 2 (right) of films deposited in presence of different first row transition metal ions; scan rate=2 mV/s.

FIG. 18 shows polarization curves of films deposited in presence of different Ni²⁺ concentrations; scan rate=1 mV/s.

FIG. 19 shows Tafel plots of films deposited in presence of different Ni²⁺ concentrations.

FIG. 20 shows polarization curves of films deposited in presence of different Co²⁺ concentrations at pH 0 (left) and pH 7 (right); scan rate=1 mV/s.

FIG. 21 shows Tafel plots of films deposited in presence of different Co²⁺ concentrations.

FIG. 22 shows consecutive polarization curves at pH 0 of tungsten sulphide films; tungsten sulphide only (left,) deposited in presence of Ni²⁺ (middle), deposited in presence of Co²⁺ (right); scan rate=2 mV/s.

FIG. 23 shows first polarization curves at pH 0 of films deposited in presence of different first row transition metal ions; scan rate=2 mV/s.

FIG. 24 shows polarization curves of electrodes prepared by adding one (4 mg), two (8 mg), three (12 mg) or four (16 mg) drops of sol, respectively, in pH 0 (1.0 M H₂SO₄); scan rate=5 mV/s.

FIG. 25 shows polarization curves of electrodes prepared with conductive graphite powder containing 10, 20 and 40 wt % MoS₃, respectively, in pH 0 (1.0 M H₂SO₄); scan rate=5 mV/s.

### DETAILED DESCRIPTION OF THE INVENTION

All publications, patent applications, patents, and other references mentioned herein are incorporated by reference in their entirety. The publications and applications discussed herein are provided solely for their disclosure prior to the filing date of the present application. Nothing herein is to be construed as an admission that the present invention is not entitled to antedate such publication by virtue of prior invention. In addition, the materials, methods, and examples are illustrative only and are not intended to be limiting.

In the case of conflict, the present specification, including definitions, will control. Unless defined otherwise, all technical and scientific terms used herein have the same meaning as is commonly understood by one of skill in art to which the subject matter herein belongs. As used herein, the following definitions are supplied in order to facilitate the understanding of the present invention.

The term “comprise” is generally used in the sense of include, that is to say permitting the presence of one or more features or components.

As used in the specification and claims, the singular form “a”, “an” and “the” include plural references unless the context clearly dictates otherwise.

As used herein, an electrocatalyst is a catalyst participating in electrochemical reactions and usually functioning at electrode surfaces or may be the electrode surface itself. The electrocatalyst assists in transferring electrons between the electrode and reactants, and/or facilitates an intermediate chemical transformation described by half-reactions. Like other catalysts, an electrocatalyst lowers the activation energy for a reaction without altering the reaction equilibrium. Electrocatalysts go a step further then other catalysts by lowering the excess energy consumed by a redox reaction's activation barriers.

As used herein, the term “amorphous” relates to noncrystalline, having no molecular lattice structure that is characteristic of solid state.

As used herein, water splitting is the general term for a chemical reaction in which water (H₂O) is separated into oxygen (O₂) and hydrogen (H₂).

As herein used, the working electrode, is the electrode in an electrochemical system on which the reaction of interest is occurring, for example in the present invention the reaction of reduction of proton to form H₂. The working electrode is often used in conjunction with an auxiliary electrode, and a reference electrode in a three electrode system. Common working electrodes can consist of inert metals such as gold, silver or platinum, to inert carbon such as glassy carbon or pyrolytic carbon, and mercury drop and film electrodes.

As herein used, the term “hydrogen evolution” is interchangeably used with the term “reduction of proton to form H₂”.

Water electrolysis utilizes electricity as the energy input, which makes it especially important in the future economy. It is conceivable that renewable energies such as solar, nuclear, wind, hydropower, geothermal, etc. would contribute more and more to the world's energy supplies. These energies are most often converted into electricity. Water electrolysis thus can also be regarded as an efficient method of energy storage.

Water electrolysis is the decomposition of water (H₂O) into oxygen (O₂) and hydrogen gas (H₂) due to an electric current being passed through the water. Usually an electrical power source is connected to two electrodes which are placed in the water. Normally hydrogen will appear at the cathode (the negatively charged electrode) whereas oxygen will appear at the anode (the positively charged electrode). Electrolysis of pure water requires excess energy in the form of overpotential to overcome various activation barriers. Without the excess energy the electrolysis of pure water occurs very slowly if at all. Decomposition of pure water into hydrogen and oxygen at standard temperature and pressure is not thermodynamically favorable. The efficacy of electrolysis is increased through the addition of an electrolyte, such as a salt, an acid, or a base and the use of electrocatalysts. Usually on an industrial scale, hydrogen is produced by the electrolysis of water by applying high-pressure and high-temperature systems in order to improve the energy efficiency of electrolysis.

In the water at cathode, a reduction reaction takes place, with electrons (e⁻) from the cathode being given to hydrogen cations to form hydrogen gas: 2H⁺(aq)+2e⁻→H₂(g). In order to achieve high efficiency in water electrolysis, electrocatalysts are needed for the reduction of proton to form H₂.

In the first embodiment, the present invention relates to the use of amorphous transition metal sulphide films or solids as electrocatalysts for the reduction of proton to form H₂. Preferably the transition metal sulphide is of formula MSₓ, where M is the transition metal and x is in the range 1.5 to 3.5 and preferably the transition metal is selected from the group comprising Mo, W, Fe, Cr, Cu, Ni. Most preferably the transition metal sulphide is MoS₂, MoS₃, WS₂ or WS₃.

In a further embodiment of the present invention, the amorphous transition metal sulphide films or solids of the invention are further doped with at least one metal selected from the group comprising Mn, Fe, Ni, Co, Cu, Sc, Ti, V, Cr, and Y. Preferably the amorphous transition metal sulphide films or solids are further doped with Ni, Co, Mn, Cu, Fe. More preferably the amorphous transition metal sulphide films or solids are further doped with Ni. Other elements such as Li, Na, K, Al, Si, O, H, C, N can be present as impurities, which may not affect the performance of the electrocatalyst of the invention.

For example, doped MoS₂ have a general formula M_{y}(MoS₂), where y=0 to 1. Furthermore, the Mo to S ratio could be from 1.5 to 3 to account for stoichiometry due to the presence of other elements and components, for example, the presence of MS.

In another embodiment, the present invention relates to the use of the electrocatalysts of the invention for producing hydrogen gas (H₂) from water or aqueous solutions. Thus preferably H₂ is originated from water or aqueous solutions. As used herein, “aqueous solution” relates to a solution in which water is solvent. The aqueous solution can contain various electrolytes and other compounds which are dissolved in water.

According to an embodiment of the present invention, the Applicants have surprisingly found that for example amorphous MoS₂ and WS₂ films and amorphous doped MoS₂ and WS₂ films are robust and active hydrogen evolution catalysts. The catalysts are prepared at room temperature and one atmosphere, and in a simple, rapid, and scalable manner. The catalysts work in water or aqueous solutions, at all pH values (i.e. 1 to 14), do not require the activation and have overpotentials as low as ca. 50 mV. The catalytic activity is not inhibited by CO, CO₂, or air.

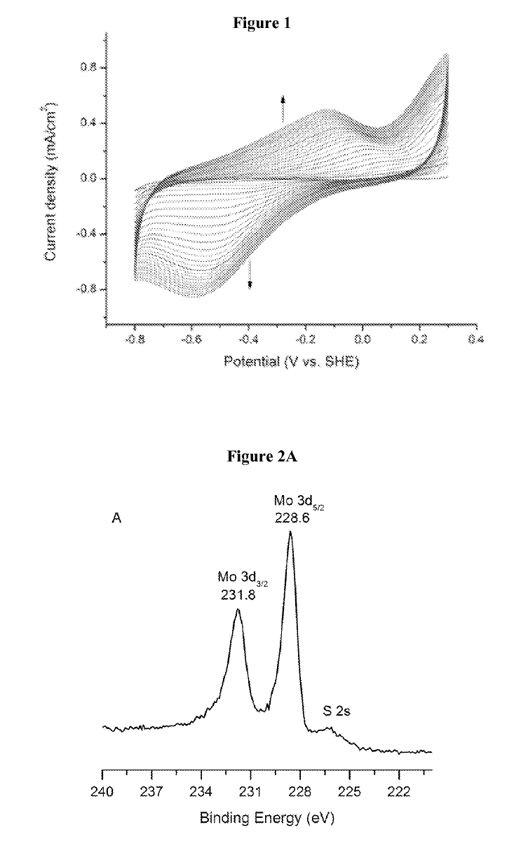

When studying the electrochemistry of [MoS₄]²⁻, the Applicants noticed that thin films were deposited onto the working electrodes by potential cycling experiments. For example, when the potential was cycled continuously from 0.3 V to −0.8 V vs. SHE (SHE=standard hydrogen electrode) at a rate of 50 mV/s in a 2.0 mM aqueous solution of (NH₄)₂[MoS₄], one oxidation and one reduction peak grew in at −0.1 V and −0.6 V, respectively, concomitant with film formation (FIG. 1). After 5 scans, the film was visible; after 25 scans, the heights of the two redox peaks approached saturation. The deposition worked on different conducting substrates such as fluorine-doped tin oxide (FTO), indium tin oxide (ITO), and glassy carbon.

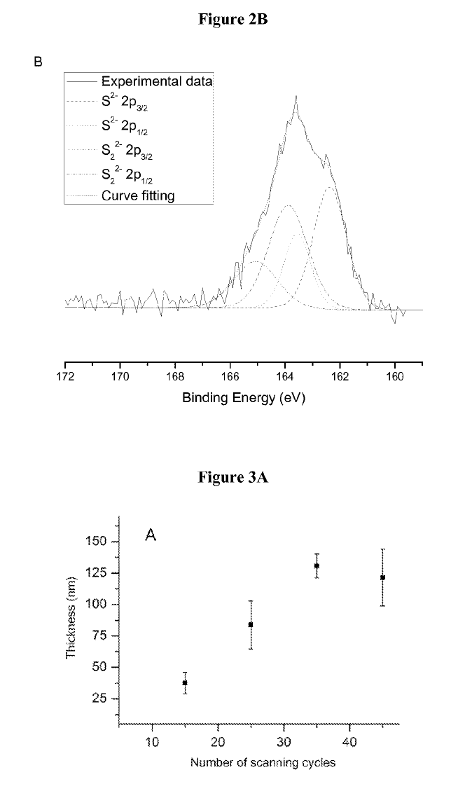

The X-ray photoelectron spectroscopy (XPS) survey spectrum of this film is dominated by the characteristic Mo and S peaks in addition to some smaller peaks of C and O from adventitious impurities. The binding energy of Mo 3d_{5/2} in the films is 228.6 eV, indicating a +4 oxidation state for the Mo ion (FIG. 2A). The S 2p spectrum (FIG. 2B) is best fit with two doublets, with S 2p_{3/2} energies of 162.4 and 163.9 eV, respectively. The spectrum indicates the presence of both S²⁻ and S₂²⁻ ligands. The spectrum is distinct from that of commercial MoS₂ particles. Quantification by XPS gave a Mo/S ratio of 1:2.9. Both the Mo and S XPS spectra are similar to those of amorphous MoS₃, for which no hydrogen evolution activity was studied. Thus, the material has been assigned as MoS₃ (named “MoS₃-DM”) with a formula of [Mo(IV)(S₂)²⁻S²⁻]. There might be some amount of amorphous MoS₂ whose XPS spectra is buried under those of MoS₃.

The formation of MoS₃-DM film from [MoS₄]²⁻ must result from an oxidation process. It was shown that anodic electrolysis of an aqueous solution of (NH₄)₂[MoS₄] at ca. 0.55 V vs. SHE gave amorphous MoS₃ films which were identified by SEM, chemical analysis, XAS, and XPS. The XPS data of those MoS₃ films resemble those in FIG. 2.

The film has a thickness of less than 100 nm, and is amorphous. No electron diffraction pattern was observed. The lack of crystallinity of the MoS₃-DM film is further confirmed by powder X-ray diffraction which showed no peak in addition to those from the tin oxide substrate (not shown).

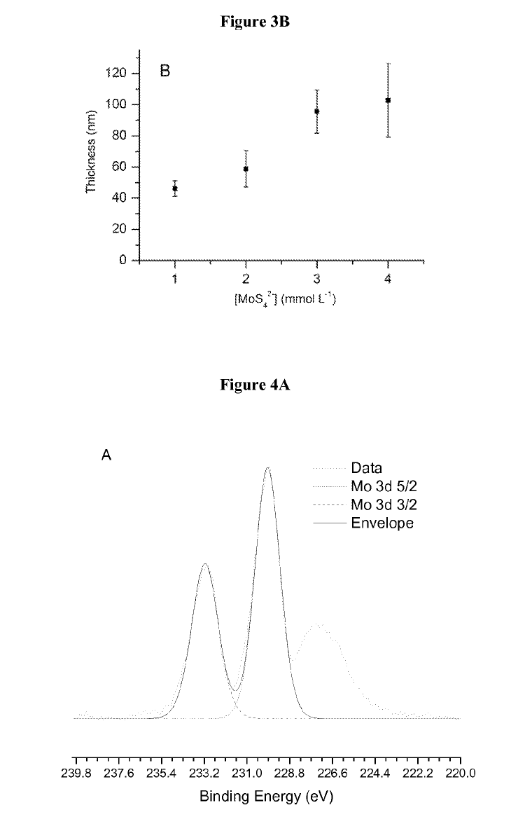

It is possible to control the MoS₃-DM film thickness by the number of scan cycles and/or varying the concentration of the solutes (FIG. 3). Most films have a thickness between 40 and 150 nm. Increasing the number of scan cycles increases significantly the thickness, up until about 35 scan cycles. Then the thickness of the film approaches an upper limit (FIG. 3, A). If deposited with the same number of scans (e.g., 25), the film is thicker when the concentration of [MoS₄]²⁻ in the starting solution is higher.

The MoS₃-DM film reported herein is prepared by cyclic voltammetry at both anodic and cathodic potentials. While MoS₃ could be formed anodically (vide supra), amorphous MoS₂ film might be formed cathodically. Indeed, it has been reported that amorphous MoS₂ film was formed when an aqueous solution of (NH₄)₂[MoS₄] was electrolyzed at −0.75 to 1.15 V vs. SHE. The MoS₂ film was X-ray amorphous, and electron probe microanalysis gave a S to Mo ratio of 1.9 to 2.1. Annealing of the MoS₂ at 550° C. in Ar then gave the crystalline MoS₂ particles. Judging from the potential window of cyclic voltammetric experiments in FIG. 1, it has been suspected that a small amount of amorphous MoS₂ was also produced together with MoS₃ in the MoS₃-DM film. To evaluate the catalytic property of different amorphous MoSₓ films, wherein x is 1.5 to 3.5, the Applicants decided to prepare MoS₃ and MoS₂ films according to the methods of Bélanger and Lévy-Clément. Furthermore, the Applicants also prepared a molybdenum sulphide film by the same continuous cyclic voltammetry as in FIG. 1, with the exception that the scans started from −0.8 to 0.3 V, and the final scan finished at −0.8 V. In this way, the formation of film was terminated at the cathodic potential.

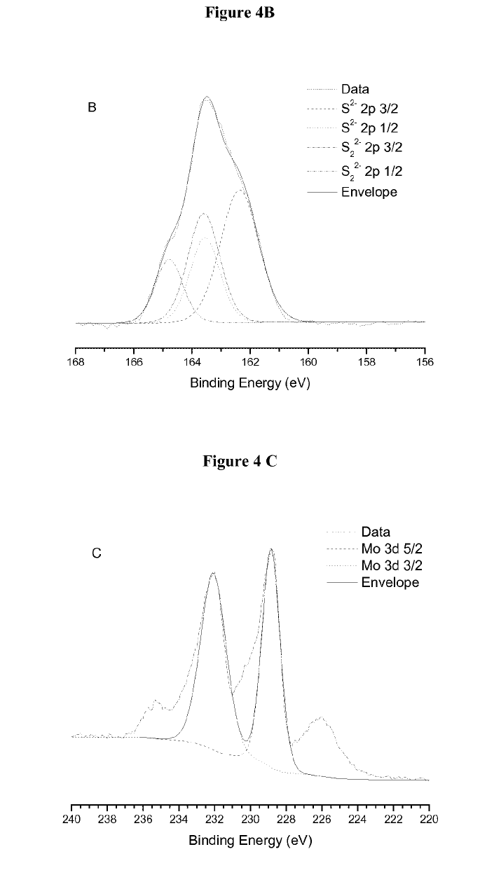

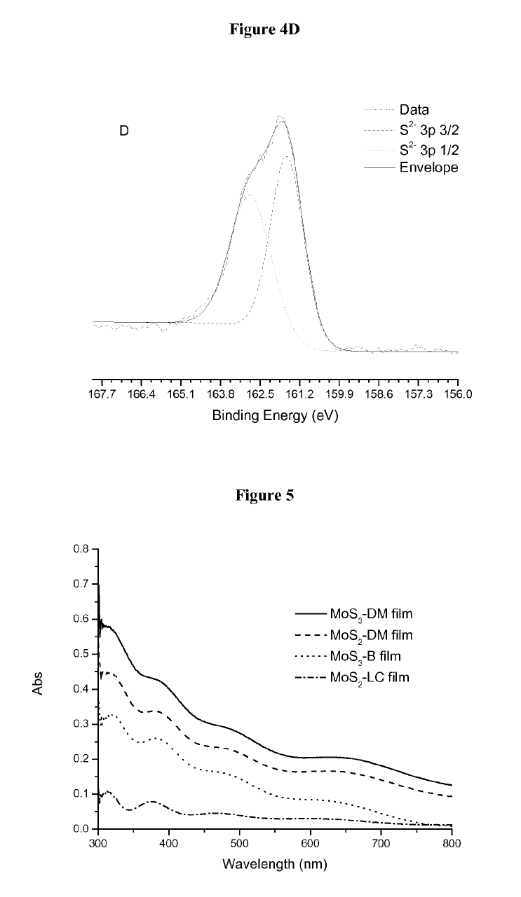

XPS was used to identify the chemical compositions of these new films. The XPS spectra of MoS₃ film prepared by the method of Bélanger (named “MoS₃—B”, FIG. 4) are very similar to those in FIG. 2. The S to Mo ratio is 3.2. The XPS spectra of MoS₂ film prepared by the method of Levy-Clement (named “MoS₂-LC”, FIG. 4) are similar to those of commercial MoS₂ particles, and did not contain the S peaks from S₂²⁻. The S to Mo ratio is 1.9. Interestingly, the molybdenum sulphide film prepared by cyclic voltammetry finishing at the cathodic potential gives XPS spectra similar to the MoS₂ film and MoS₂ particles (FIG. 4). The S to Mo ratio is 2. The Applicants assign this film to MoS₂-DM, although it probably also contains a small amount of MoS₃ that cannot be detected by XPS in the presence of a large amount of MoS₂.

In addition to XPS, UV-Vis absorption spectroscopy was used to characterize the four different types of MoSₓ films. The films exhibit similar spectra with absorption peaks at ca. 310, 375, 480, and 630 nm (FIG. 5), probably because they all contain Mo(IV) ions and S²⁻ ligands. No absorption peaks associated with the S₂²⁻ ligands in MoS₃-DM and MoS₃—B films could be located.

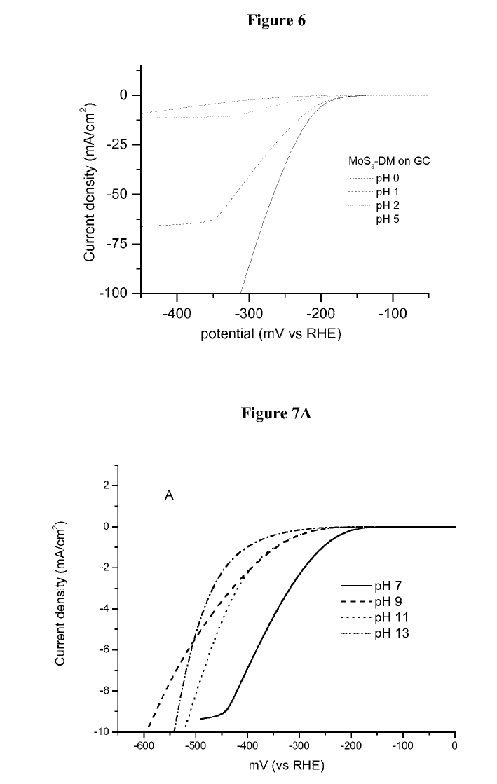

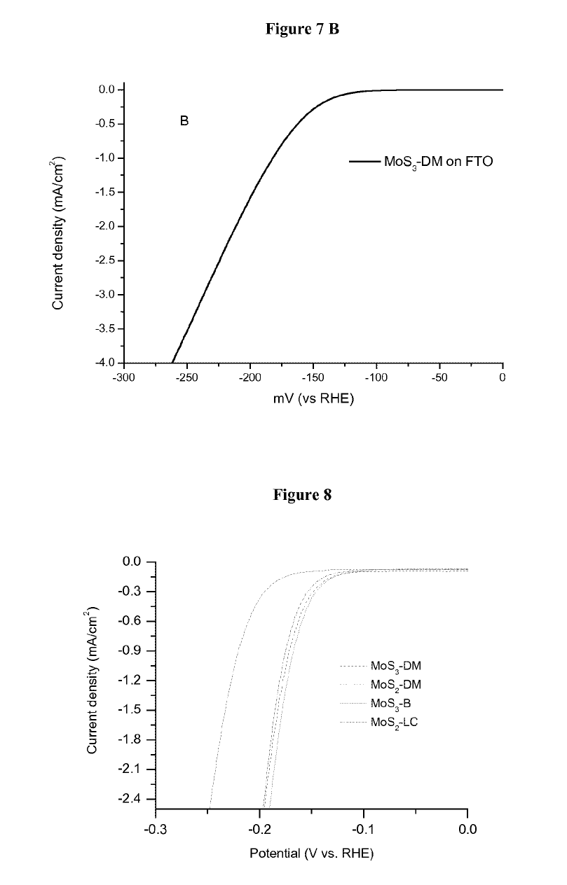

The catalytic activity of the four MoSₓ films was studied. FIG. 6 shows the polarization curves of MoS₃-DM on a rotating glassy carbon disk electrode at pH=0 to 5; FIG. 8 shows its polarization curves at pH=7, 9, 11, 13, and the curve for MoS₃-DM deposited on FTO at pH=2. The MoS₃-DM films display high catalytic activity for hydrogen evolution at a wide range of pH values. As expected, the apparent current densities decrease with an increase of pHs (FIG. 7). At low overpotentials (η<250 mV), the current is independent of rotating rates and therefore kinetic-controlled. The amorphous MoS₃-DM is more active than the MoS₂ single crystals deposited on Au(111). The apparent current density (J) for the MoS₃-DM film at η=150 mV is ca. 0.4 mA/cm² at pH=0, higher than that for the MoS₂ crystals at the same overpotential (J≈0.2 mA/cm²).

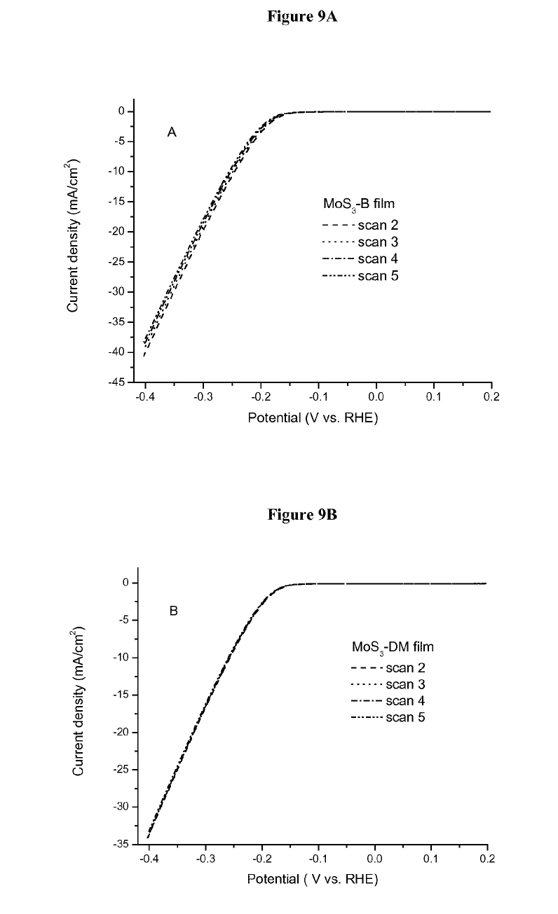

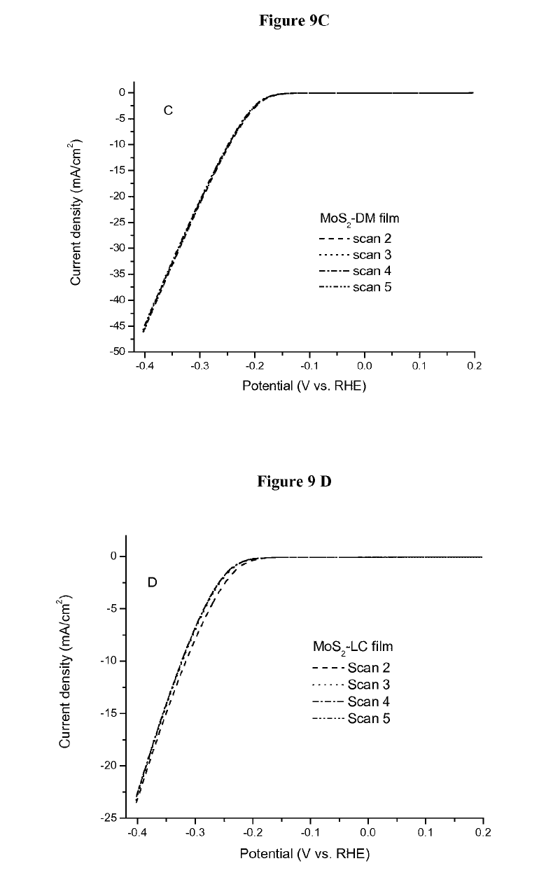

The catalytic activity of MoS₃—B film is nearly identical to that of MoS₃-DM film (FIG. 8), except that the activity decreases gradually during consecutive scans (FIG. 9). In contrast, the activity of MoS₃-DM film remains constant during consecutive scans (Fig.). The higher stability of MoS₃-DM film compared to MoS₃—B film suggests an advantage for the potential-cycling process.

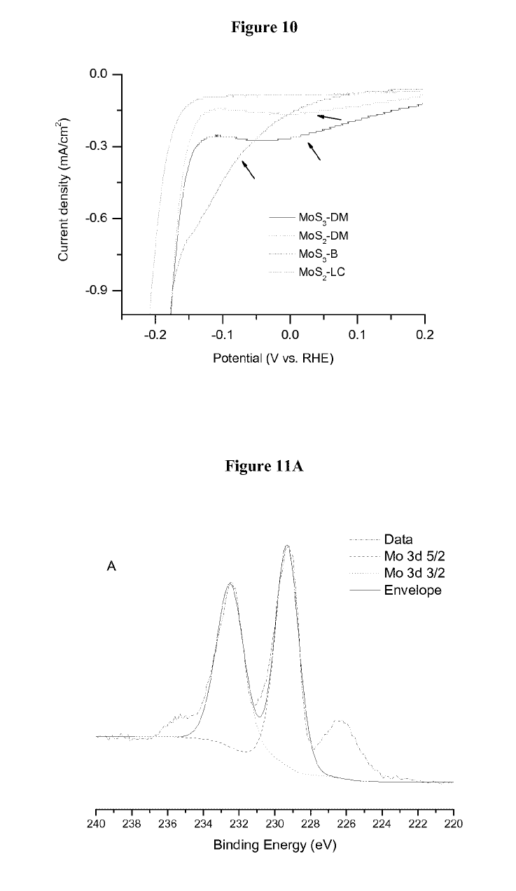

Interestingly, the MoS₂-DM film, made also through the potential-cycling process, is as active and stable as the MoS₃-DM film (FIGS. 9 and 10). In order to determine what is the active catalyst for all the amorphous MoSₓ films, the Applicants studied the MoSₓ films after catalysis (vide infra). The MoS₂-LC film, prepared by potentiostatic cathodic deposition, is the least active catalyst (FIG. 8). Its activity also decreases during consecutive scans (FIG. 9).

All four MoSₓ films exhibited hydrogen evolution activity. These films are better considered as pre-catalysts. To verify if these pre-catalysts were activated to form the same catalyst under the conditions for hydrogen evolution, the Applicants examined the first polarization curves for the freshly prepared films. Indeed a pre-activation process was found for MoS₃-DM, MoS₃—B, MoS₂-DM, but not for MoS₂-LC.

For MoS₃-DM and MoS₃—B, a reduction peak was observed prior to hydrogen evolution (FIG. 10). The same reduction peak was observed for MoS₂-DM, but it was significantly smaller. No reduction was observed for MoS₂-LC. For all MoSₓ films, no reduction peak before hydrogen evolution was observed in the second and following polarization scans (FIG. 8).

Being not bound to the theory, according to the Applicants, the reduction peak in the first scan originated from the reduction of MoS₃ to MoS₂, whereby the S₂²⁻ accepts two electrons to form S²⁻. The MoS₂ species is then responsible for the hydrogen evolution catalysis. To verify this, the Applicants carried out a XPS study on the MoS₃-DM film after several polarization measurements. The XPS spectra of the film have changed, and are similar to those of MoS₂ (FIG. 11). The peaks due to S₂²⁻ disappeared.

The UV-vis spectra of the four MoSₓ films after multiple polarization scans were measured and showed to be similar. They are also similar to the spectra of freshly prepared samples. Whereas the UV-Vis spectra of these films are not sensitive to the presence or absence of S₂²⁻ ligand, they suggest that the bulk compositions of the films remain MoSₓ, and most likely MoS₂.

It thus appears that amorphous MoS₂ is the real catalyst for all four MoSₓ films. The MoS₃-DM and MoS₂-DM films reported here are the best precatalysts in terms of activity and stability and they are indistinguishable. For this reason, only MoS₃-DM film is used for the further studies herein.

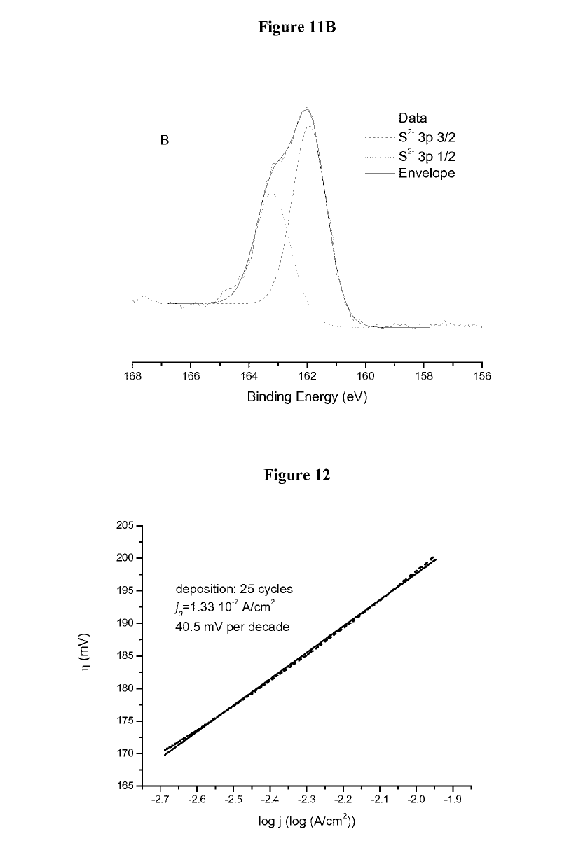

Tafel behavior was observed for the polarization curve of MoS₃-DM on glassy carbon at η=120 to 200 mV and pH=0. Analysis of the data at η=170 to 200 mV gave a Tafel slope of 40 mV per decade and an apparent Jₒ of ca. 1.3×10⁻⁷ A/cm⁻² for a film made from 25 scanning cycles (FIG. 12).

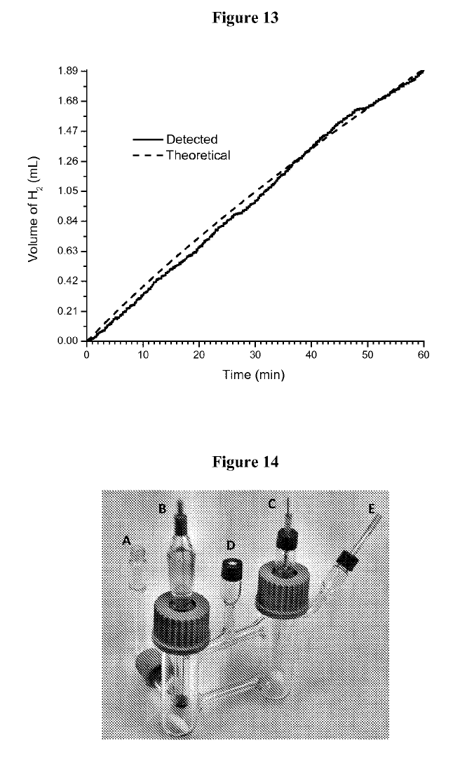

Bulk electrolysis was carried out to determine the current efficiency of hydrogen evolution. In a 1M solution of H₂SO₄, the MoS₃-DM film deposited on a glassy carbon disk (25 cycles) gave current densities of 160 and 14 mA/cm² at η=300 and 200 mV, respectively. These current densities are among the highest reported for non-noble catalysts in acidic or neutral conditions. For comparison, a recently reported and very active Ni-bisphosphine/carbon nanotube based H₂ production catalyst gave a current density of 20 mA/cm² at η=300 mV. The Faraday yields for H₂ production were found to be quantitative within experimental errors. By measuring pressure change during water splitting, it was possible to monitor H₂ production in-situ. FIG. 13 shows that the current efficiency remains quantitative for hours. Thus, while it was reported that vacuum-dried MoS₃ can absorb H₂ to form H₂S, under the electrolysis conditions, the MoS₃-DM film reported here remains stable and active during H₂ production.

The catalytic activity of the MoS₃-DM films depends on the thickness. Films deposited by higher numbers of cycles are more active. The intrinsic catalytic activity is however measured by the turnover frequency (TOF) for each active site. The Applicants attempted to quantify the active sites by electrochemistry. While it is difficult to assign the observed peaks to a given redox couple, the integrated charge over the whole potential range should be proportional to the total number of active sites. Assuming a one-electron process for both reduction and oxidation, the upper limit of active MoS₃-DM sites could be calculated for each film. Up to η=200 mV, a fairly uniform activity was observed for films made from different scan cycles, suggesting that even though there is a significant uncertainty in the estimation of the active sites, self-consistent information on the site-averaged catalytic activity can be extracted from this analysis. At η>200 mV, some deviations were observed, probably due to the influence of substrate diffusion.

The rough estimation of TOFs makes it possible to compare the activity of MoS₃-DM film with other catalysts. The most active catalyst, Pt, has a TOF of 0.8 s⁻¹ at η=0 and pH=0; to reach the same TOF, MoS₃-DM films need an overpotential of ca. 220 mV. An interesting Mo-oxo system is reported to work on a mercury pool electrode on which it might be absorbed. It has a TOF of 2 s⁻¹ at η≈1000 mV at pH=7. The TOF of MoS₃-DM film reaches the same value at η≈240 mV and pH=0. The Mo-oxo system uses water as the substrate, while the MoS₃-DM system uses protons as the substrate. To make a fair comparison, the Applicants also measured the TOFs of a MoS₃-DM film at pH=7. The Mo-oxo system has a TOF of 0.3 s⁻¹ at η≈600 mV, while the MoS₃-DM film reaches the same TOF at η≈340 mV. Thus, amorphous MoS₃-DM compares favorably with the best known non-precious catalysts in terms of bulk catalytic properties.

Given that single crystals and nanoparticles of MoS₂ but not bulk MoS₂ are active H₂ evolution catalysts, the discovery that the four amorphous MoSₓ films are active catalysts was unexpected. The overall catalytic activity per geometric area of MoS₃-DM and MoS₂-DM film is higher than that of MoS₂ single crystals (vide infra) and nanoparticles (J≈160 mA/cm² at η≈300 mV for MoS₃-DM film and J<2 mA/cm² at η≈300 mV for MoS₂ nanoparticles).

Not being bound to the theory, Applicants believe that H₂ evolution by amorphous MoS₂ seems to proceed via a different mechanism from that by MoS₂ single crystals and nanoparticles. MoS₂ films have a Tafel slope of 40 mV per decade. This Tafel slope is different from those of MoS₂ crystals (55 to 60 mV per decade) or MoS₂ nanoparticulate (120 mV per decade). According to the classic theory on the mechanism of hydrogen evolution, a Tafel slope of 40 mV indicates that the surface coverage of adsorbed hydrogen is less than 10%, and hydrogen production occurs via a fast discharge reaction (eq. 4) and then a rate-determining ion+atom reaction (eq. 5).

discharge reaction H₃O⁺+e+cat [symbol] cat−H+H₂O (4)

ion+atom reaction H₃O⁺+e+cat−H [symbol] cat+H₂+H₂O (5)

combination reaction cat−H+cat−H [symbol] 2cat+H₂ (6)

A Tafel slope of 60 mV per decade indicates a larger surface coverage of adsorbed hydrogen and a rate-determining recombination (eq. 6) or ion+atom reaction. A Tafel slope of 120 mV could arise from various reaction pathways depending on the surface coverage. The different Tafel slopes point to a unique catalytic property for amorphous MoS₂ film when compared to crystalline forms of MoS₂. More work is required to shed insight into the mechanism of H₂ evolution at the molecular level. Given that both Mo and S are capable of accepting electrons and protons, a ‘bifunctional’, metal-ligand cooperative mode of catalysis is likely, and the coordinatively unsaturated S ligand might play an important role.

Amorphous films are solid layers of a few nm to some tens of μm thickness deposited on a substrate. Preferably most films have a thickness between 40 nm and 150 nm for MoS₂ and between 60 nm and 400 nm for Ni—MoS₂ films.

The films can be deposited on any conducting or semi-conducting substrate, comprising, but not limited to, glassy carbon disc, reticulated vitreous carbon foam, FTO coated glass, indium tin oxide, carbon fiber, carbon nanotube, carbon clothes, graphene, Si, Cu2O, TiO2, titanium metal, boron-doped diamond, and differents metals. Preferably FTO coated glass is used, because one can modify numerous electrodes and store them. Also the analysis of the film on FTO coated glass is much easier than on glassy carbon or reticulated vitreous carbon, e.g. the analysis by scanning electron microscopy or UV/VIS spectroscopy.

Besides films, the amorphous transition metal sulphide can be in the form of solids. For example, amorphous MoS₂ solids can be made by a modification of the method already described by Poulomi Roy, Suneel Kumar Srivastava in Thin Solid Films, 496 (2006) 293-298. The solids can be put onto a substrate such as FTO and show catalytic activity for hydrogen evolution reaction.

The same metal sulphide films were deposited onto a rotating glassy carbon disk electrode. The films display high catalytic activity for hydrogen evolution at a wide range of pH values. In all acidic and neutral aqueous solutions, hydrogen evolution occurs at η100 mV. As expected, the apparent current densities decrease with an increase of pH values. At low overpotentials (η<250 mV), the current is independent of rotating rates and therefore kinetic-controlled. Tafel analysis of the polarization curves could be made from η=120 to 200 mV. For Ni—MoS₂ films, the exchange current densities at different pHs are in the order of 10⁻⁴ to 10⁻³ mA/cm². The Tafel slops change from 45 mV per decade at pH=0 to 73 mV per decade at pH=7 (see Table 1). This is an indication for the change of mechanism for the catalysis at different pH values. Similar trends were observed for MoS₂ films. The films also displayed activity in basic media, but with higher overpotentials and lower current densities. Again the Ni-doped MoS₂ film exhibits higher activity than the MoS₂ film.

TABLE 1
Tafel data obtained from the polarization curves recoded for modified
glassy carbon rotating disk electrodes. The scan rate is 2 mV/s. The
analysis was done on data collected at 120 to 200 mV overpotential.

| | MoS₂ | | Ni-doped MoS₂ | |
|---|---|---|---|---|
| | slope (mV per | | slope (mV per | |
| | decade) | i₀ (mA/cm²) | decade) | i₀ (mA/cm²) |
| pH 0 | 36.6 | 2.16 · 10⁻⁵ | 44.8 | 1.73 · 10⁻⁴ |
| pH 1 | 36.8 | 1.80 · 10⁻⁵ | 48.8 | 3.68 · 10⁻⁴ |
| pH 2 | 37.5 | 5.21 · 10⁻⁶ | 57.4 | 6.17 · 10⁻⁴ |
| pH 5 | 55.4 | 4.15 · 10⁻⁵ | 68.4 | 1.64 · 10⁻³ |
| pH 7 | 46.2 | 1.02 · 10⁻⁵ | 73.2 | 3.42 · 10⁻³ |

One limitation of Pt-based hydrogen evolution catalysts is that they are easily poisoned by impurities such as carbon monoxide (CO). FIG. 4 shows the polarization curves of a Pt-disk electrode at pH=0. When a small amount of CO gas was introduced, the catalytic activity diminished dramatically. When CO₂ gas was introduced, the catalytic activity also diminished but to a lesser degree (FIG. 13). The latter is probably due to the reduction of CO₂ in water by Pt to form CO, which then poisons Pt. On the contrary, the catalytic activity of both Ni-doped MoS₂ and MoS₂ films are not affected by CO or CO₂, as shown in FIG. 4 and FIG. 14. The stability of these synthetic catalysts against impurity gases offers an important advantage in practical uses.

The catalytic properties of Ni-doped MoS₂ and MoS₂ films were further investigated under air. Nearly identical polarization curves were obtained in N₂-purged and aerobic aqueous solutions at pH=0. Therefore the metal sulphide catalysts are not inhibited by air. This is a highly desirable feature as electrolysis can be carried out under aerobic conditions. On the contrary, most synthetic catalysts based on organometallic and coordination compounds are unstable in air under electrolysis conditions. They only work in degassed solutions and under an inert atmosphere.

As mentioned above, other transition metal ions than nickel were used as doping metal elements. The preparation of the complexes in situ is an easy and quick way to try different transition metal ions as central ions. In one example, this method was used to deposit films containing Co²⁺, Fe²⁺ and Mn²⁺, respectively. With each transition metal ion, three FTO coated glass plates were modified by repeating cyclic voltammetry, performing 15, 25 and 35 cycles, respectively.

In the further embodiment, the present invention provides simple, rapid, and highly manufacturable procedure for the deposition of transition metal sulphide films or solids on various conducting substrates, including electrode substrate. The synthetic procedures are simple, versatile, and are amenable to large-scale manufacture. The deposition can be done by using the electrochemical deposition (electroplating) or chemical depositor.

For example, the electrochemical deposition is a process of coating an object, usually metallic, with one or more relatively thin, tightly adherent layers (films) of some other metal by means of electrochemical process, which involves electrical and chemical energy. During this process, the object to be plated is immersed in a solution containing dissolved salts of the metal to be deposited. The set up is made up of a cathode and an anode with the object to be plated usually the cathode connected to the negative terminal of a direct current source. To complete the electrical circuit, another metal is connected to the positive terminal and both are immersed in the solution. When current applied, the electrical energy carried is converted to chemical energy by decomposition, a reaction in which the elements are divided into positive and negative charged ions. The movement of positively charged ions towards the cathode surface (substrate) results to metal deposition.

The Applicants found that electrodeposition takes place by reversible potential cycling of the solution containing the catalyst precursor. This electrodeposition method has some advantages. For example, it is possible to monitor the formation of the films when they are made, and thus control the thickness of the films according to the scanning cycles. Furthermore, the deposition can occur at a potential window where no other reactions such as hydrogen evolution occur. While catalyst can also be deposited by cathodic electrolysis at a rather negative potential with the same precursors, hydrogen evolution occurs together with electrodeposition. The deposition by potential cycling is therefore more efficient.

In still another embodiment, the present invention provides electrode for use in production of hydrogen gas (H₂) from water or aqueous solutions comprising an electrode substrate, wherein the amorphous transition metal sulphide films or solids of the present invention are deposited on said electrode substrate. Preferably said amorphous transition metal sulphide films or solids are selected from the group comprising amorphous MoS₂ film or solid, amorphous MoS₃ film or solid, amorphous WS₂ film or solid, and amorphous WS₃ film or solid.

The electrode (cathode) of the invention can be used for hydrogen evolution at mild conditions (acidic and weakly basic conditions). Preferably, the electrode substrate is any conducting or semi-conducting substrate, selected from the group comprising glassy carbon disc, reticulated vitreous carbon foam, FTO coated glass, indium tin oxide, carbon fiber, carbon nanotube, carbon clothes, graphene, Si, Cu2O, TiO2, titanium metal, and boron-doped diamond.

In still further embodiment, the present invention provides electrolysers for the hydrolysis of water comprising the electrode of the invention. The water electrolyser is the exact reverse of a hydrogen fuel cell; it produces gaseous hydrogen and oxygen from water. Electrolyser technology may be implemented at a variety of scales wherever there is an electricity supply to provide hydrogen and/or oxygen for virtually any requirement. It may be located conveniently close to the points of demand (to minimise gas infrastructure costs) or at large sites feeding into gas distribution infrastructures involving ships, tankers and/or pipelines.

Electrolysers are usually of high conversion efficiency, with the best commercially available examples approaching 90% efficiency. Accordingly the carbon-footprint of the generated H₂ and O₂ is principally a function of the input electricity. There are three principal types of water electrolyser: alkaline (referring to the nature of its liquid electrolyte), proton-exchange membrane (PEM, referring to its solid polymeric electrolyte), and solid-oxide (referring to its solid ceramic electrolyte). The alkaline and PEM electrolysers are well proven devices, while the solid-oxide electrolyser is as yet unproven. The PEM electrolyser is particularly well suited to highly distributed applications. The alkaline electrolyser currently dominates global production of electrolytic hydrogen.

The present invention also encompasses an electrical generator comprising:
a fuel source, such as an electrolyser, which comprises the electrocatalysts of the invention for producing hydrogen gas from water or aqueous solution,
a fuel line, such as a tube adapted to deliver hydrogen gas from the fuel source to a hydrogen fuel cell,
a hydrogen fuel cell, which converts hydrogen gas produced by a fuel source into an electrical current and water (a hydrogen fuel cell generates electricity inside a cell through reactions between hydrogen (a fuel) and an oxidant (oxygen from the air), triggered in the presence of an electrolyte),
   and wherein said electrical generator provides electricity for virtually any requirement, such as for example electrical engines or motors.

The electrodes of the present invention can be employed in many other applications which use cathodes. Such applications can be, but not limited to, the use as cathode material for waste-water treatments (see for example Environ. Sci. Technol., 2008, 42, pp. 3059-3063) and bio-electrolysis (see for example Environ. Sci. Technol., 2008, 42, pp. 8630-8640).

Another application of the invention can be in solar fuel conversion technologies, wherein the light is converted by a light-harvesting device into charges which provide electrons to the electrocatalysts of the invention for making hydrogen.

Further, the electrocatalysts of the invention can be subjected to post-treatments such as annealing treatments at different temperatures. These treatments might modify the micro-structure of the catalysts and thus modify the catalytic performance. Annealing can lead to higher catalyst activity, better selectivities, or both of these enhancements. Effective conditions for annealing can include temperatures such as about 200-1000° C., preferably 500-900° C. The present invention is not limited to any particular range of annealing temperatures. It will be appreciated by a skilled person in the art that lower temperatures can be employed but will generally necessitate longer annealing times, because annealing is generally favored at higher temperatures.

Applicants also observed that amorphous MoS₃ solids can be obtained upon acidification of a solution prepared from MoO₃ and sodium sulphide, making the preparation even simpler than the preparations reported in the prior art. Thus the present invention also provides a method for preparing amorphous MoS₃ solids comprising the steps of:
a) dissolving molybdenum trioxide (MoO₃) in an aqueous solution of sodium sulphide,
b) acidifying the solution of step a),
c) recovering the obtained amorphous MoS₃ solids

Typically the acidification is done by an aqueous solution of an acid, for example HCl. Also typically the recovery of the obtained amorphous MoS₃ solids is done by any suitable methods known to the person skilled in the art. For example recovering can be done by boiling to remove the H₂S present in solution, filtering under vacuum, washing with water ethanol and suspending in acetone.

Those skilled in the art will appreciate that the invention described herein is susceptible to variations and modifications other than those specifically described. It is to be understood that the invention includes all such variations and modifications without departing from the spirit or essential characteristics thereof. The invention also includes all of the steps, features, compositions and compounds referred to or indicated in this specification, individually or collectively, and any and all combinations or any two or more of said steps or features. The present disclosure is therefore to be considered as in all aspects illustrated and not restrictive, the scope of the invention being indicated by the appended Claims, and all changes which come within the meaning and range of equivalency are intended to be embraced therein.

The foregoing description will be more fully understood with reference to the following Examples. Such Examples, are, however, exemplary of methods of practicing the present invention and are not intended to limit the scope of the invention.

### Examples

### Chemicals and Reagents

All manipulations were carried out under an inert N₂(g) atmosphere using glovebox techniques unless otherwise mentioned. Unless noted, all other reagents were purchased from commercial sources and used without further purification.

### Physical Methods

GC measurement was conducted on a Perkin-Elmer Clarus 400 GC with a FID detector a TCD detector and a 5 Å molecular sieves packed column with Ar as a carrier gas. UV-Vis measurements were carried out using a Varian Cary 50 Bio Spectrophotometer controlled by Cary WinUV software. SEM secondary electron (SE) images were taken on a Philips (FEI) XLF-30 FEG scanning electron microscope. XRD measurements were carried out on a PANalytical X'Pert PRO diffractometer using Cu K_{α1} radiation (0.1540 nm). Electrochemical measurements were recorded by an IviumStat electrochemical analyzer or an EG&G Princeton Applied Research Potentiostat/Galvanostat model 273. A three-electrode configuration was used. For polarization and electrolysis measurements, a platinum wire was used as the auxiliary electrode and an Ag/AgCl (KCl saturated) electrode was used as the reference electrode. The reference electrode was placed in a position very close to the working electrode with the aid of a Luggin tube. For rotating disk measurements, an Autolab Rotating Disk Electrode assembly was used. Potentials were referenced to reversible hydrogen electrode (RHE) by adding a value of (0.197+0.059 pH) V. The polarization curves measured under one atmosphere of H₂ are nearly identical to those collected in the absence of external H₂, indicating that the potentials measured in the latter experiments are close to the thermodynamically-calibrated values. Ohmic drop correction was done prior to Tafel analysis. Film thickness was measured using an Alpha Step 500 (KLA-Tencor) stylus-based surface profiler. Pressure measurements during electrolysis were performed using a SensorTechnics BSDX0500D4R differential pressure transducer. Both current and pressure data were recorded simultaneously using an A/D Labjack U12 interface with a sampling interval of one point per second. X-ray photoelectron spectroscopy (XPS) data were collected by Axis Ultra (Kratos analytical, Manchester, UK) under ultra-high vacuum condition (<10⁻⁸ Torr), using a monochromatic Al K_{α} X-ray source (1486.6 eV). The source power was maintained at 150 W (10 mA, 15 kV). Gold (Au 4f_{7/2}) and copper (Cu 2p_{3/2}) lines at 84.0 and 932.6 eV, respectively, were used for calibration, and the adventitious carbon is peak at 285 eV as an internal standard to compensate for any charging effects. For quantification, relative sensitivity factors from the supplier were used.

### Deposition of Films

### I. On Glassy Carbon Electrodes

A 3 mm diameter glassy carbon rotating disk working electrode from Autolab (6.1204.300GC) and a 3 mm diameter glassy carbon working electrode from CH Instruments (CHI 104) were used. The electrodes were polished with two different Alpha alumina powder (1.0 and 0.3 micron from CH Instruments) suspended in distilled water on a Nylon polishing pad (CH Instruments) and with Gamma alumina powder (0.05 micron from CH Instruments) suspended in distilled water on a Microcloth polishing pad (CH Instruments). Before going to the next smaller powder size and at the end of polishing, the electrodes were thoroughly rinsed with distilled water.

Deposition of MoS₃-DM: The modification was carried out in a glove box under nitrogen. The freshly polished electrode was immersed into a 2 mM solution of (NH₄)₂[MoS₄] in 0.1 M NaClO₄ in water (8 mL). Both chemicals were used as received (Aldrich). Thirty consecutive cyclic voltammograms were carried out on an Ivium Stat potentiostat (Ivium Technologies) with a saturated silver/silver chloride reference electrode (separated by a porous vycor tip) and a titanium wire counter electrode. The cyclic voltammograms were performed between +0.1 and −1.0 V vs. Ag/AgCl (sat.) and a scan rate of 0.05 V/s was employed. Finally, the modified electrode was rinsed with distilled water.

### II. On FTO-Coated Glass Plates

On FTO-coated glass plates: FTO-coated glass was cut down to rectangular plates of 9×25 mm. The plates were cleaned in a bath of 1M KOH in ethanol and washed with ethanol, water and acetone. An adhesive tape with a hole of 5 mm diameter was attached on each plate in such a way that a circle of 5 mm diameter in the bottom part and a small strip at the top of the plate remained uncovered. The plate will be modified in the area of the circle only and the uncovered strip serves as electrical contact.

Depositions of MoS₃-DM: The modification was carried out in a glove box under nitrogen. The freshly prepared FTO electrode was immersed into a 2 mM solution of (NH₄)₂[MoS₄] in 0.1M NaClO₄ in water (6 mL). Both chemicals were used as received (Aldrich). Fifteen, twenty-five or thirty-five consecutive cyclic voltammograms were carried out on an Ivium Stat potentiostat (Ivium Technologies) with a saturated silver/silver chloride reference electrode (separated by a porous vycor tip) and a platinum wire counter electrode. The cyclic voltammograms were performed between +0.1 and −1.0 V vs. Ag/AgCl (sat.) and a scan rate of 0.05 V/s was employed. Finally, the modified electrode was rinsed with distilled water.

Note: to ensure that the catalytic properties of the MoS₃-DM films are not due to Pt particles that can be accidently deposited during film formation, the Applicants also deposited MoS₃-DM films using Ti as the counter electrode. The polarization curves of these films were measured using Ti as the counter electrode as well. At overpotentials below 300 mV, the polarization curves are nearly identical to those measured using Pt as the counter electrode. Some discrepancy was found at higher overpotentials, probably because the Ti counter electrode is not able to supply enough current at those potentials. These results rule out the possibility of Pt contamination.

Deposition of MoS₂-DM film: Same procedure as described for MoS₃-DM film, but the cyclic voltammograms were performed between −1.0 and +0.1V vs. Ag/AgCl (sat.), i.e. they started and ended at −1.0 V vs. Ag/AgCl (sat.).

Deposition of MoS₃—B: Same conditions as described above, but instead of consecutive cyclic voltammograms, a constant potential of +0.3 V vs. Ag/AgCl (sat.) was applied for 70 s.

Deposition of MoS₂-LC film: Same conditions as described above, but instead of consecutive cyclic voltammograms, a constant potential of −1.3 V vs. Ag/AgCl (sat.) was applied for 160 s.

### Ohmic Drop Correction:

The ohmic drop correction of polarization curves has been performed according to the method given in the literature (D. M. Schub, M. F. Reznik, Elektrokhimiya, 21 (1985) 937; N. Krstajic, S. Trasatti, Journal of Applied Electrochemistry. 28 (1998) 1291; and L. A. De Faria, J. F. C. Boodts, S. Trasatti, Journal of Applied Electrochemistry, 26 (1996) 1195). The overpotential η (V) observed during an experiment is given by equation (1):

η=a+b ln j+jR (1)

where a (V) is the Tafel constant, b (V dec⁻¹) is the Tafel slope, j (A cm⁻²) is the current density and R (Ωcm⁻²) is the total area-specific uncompensated resistance of the system, which is assumed to be constant. The derivative of Eq. (1) with respect to current density gives Eq. (2) from which b and R can be easily obtained by plotting d/dj as a function of 1/j.

$$\frac{d η}{d j} = \frac{b}{j} + R \qquad ( 2 )$$

The estimation of R allows correcting the experimental overpotential by subtracting the ohmic drop jR according to equation (3):

η_{corr}=η−jR (3)

During the calculations, the derivative dη/dj was replaced by their finite elements Δη/Δj estimated from each pair of consecutive experimental points.

### Bulk Electrolysis

Electrolysis experiments were performed in an H shape cell (FIG. 14). The platinum counter electrode was separated from the solution through a porous glass frit (porosity 3) and this whole assembly inserted into one side of the H cell. The modified working electrode was inserted in the other side of the cell, together with a magnetic stirring bar and a Luggin capillary. Two small inlets were present in the cell allowing the connection to the pressure monitoring device and the other kept closed by a septum for sampling of the gas phase. The whole cell apparatus is gas-tight and the pressure increase is proportional to the gases generated (H₂+O₂). It is assumed that for 2 moles of H₂ generated in the working electrode, 1 mole of O₂ is generated in the counter electrode. Prior to each experiment, the assembled cell was calibrated by injecting known amounts of air into the closed system and recording the pressure change, after the calibration the cell was purged with nitrogen for 20 minutes and the measurements were performed. Control experiments were performed using platinum as a working electrode and a quantitative Faraday yield was obtained by measuring the pressure (97-102%) and confirmed by GC analysis of the gas in the headspace (92-96%) at the end of the electrolysis. For the electrochemical modified electrodes the films were deposited on glassy carbon electrodes and electrolysis carried out during 60 minutes. At the end the current efficiency was determined by the pressure change in the system and confirmed by GC analysis.

### Calculation of Active Sites

The MoS₃-DM film was deposited as described above during a certain number of consecutive cyclic voltammograms in a solution of (NH₄)₂MoS₄ in pH=7 phosphate buffer (modification cycles). After 6, 9, 12, 15 and 18 modification cycles, cyclic voltammetry measurements were carried out in pH=7 phosphate buffer only (blank measurements). The potential window and scan rate applied for these blank measurements were the same as those applied for the modification cycles. Later, the absolute components of the voltammetric charges (cathodic and anodic) reported during one single blank measurement were added. Assuming a one electron redox process, this absolute charge was divided by two. The value was then divided by the Faraday constant to get the number of active sites of the film. Following this procedure, the number of active sites (in mol) after 6, 9, 12, 15 and 18 modification cycles was determined.

### Determination of the Turnover Frequency (TOF)

When the number of active sites is known, the turnover frequencies (in s⁻¹) were calculated with the following equation:

$$TOF = \frac{I}{Fn} \frac{1}{2}$$

I: Current (in A) during the linear sweep measurement after 6, 9, 12, 15 or 18 modification cycles, respectively.
F: Faraday constant (in C/mol).
n: Number of active sites (in mol) after 6, 9, 12, 15 or 18 modification cycles, respectively. The factor ½ arrives by taking into account that two electrons are required to form one hydrogen molecule from two protons.

### Films Deposited in Presence of First Row Transition Metal Ions

The modification was carried out in a glove box under nitrogen. A 2 mM solution of MCl₂ (M=Zn, Cu, Ni, Co, Fe or Mn) in 0.1M NaClO₄ (3 ml) was added dropwise to a 4 mM solution of (NH₄)₂MoS₄ in 0.1M NaClO₄ (3 ml) under stirring. All chemicals were used as received (Aldrich or Acros). The freshly cleaned FTO coated glass was immersed into the resulting solution. Twenty-five consecutive cyclic voltammograms were carried out on an Ivium Stat potentiostat (Ivium Technologies) with a saturated silver/silver chloride reference electrode (separated by a porous vycor tip) and a titanium wire counter electrode. The cyclic voltammograms were performed between +0.1 and −1.0 V vs. Ag/AgCl (sat.) and a scan rate of 0.05 V/s was employed. Finally, the modified electrode was rinsed with distilled water.

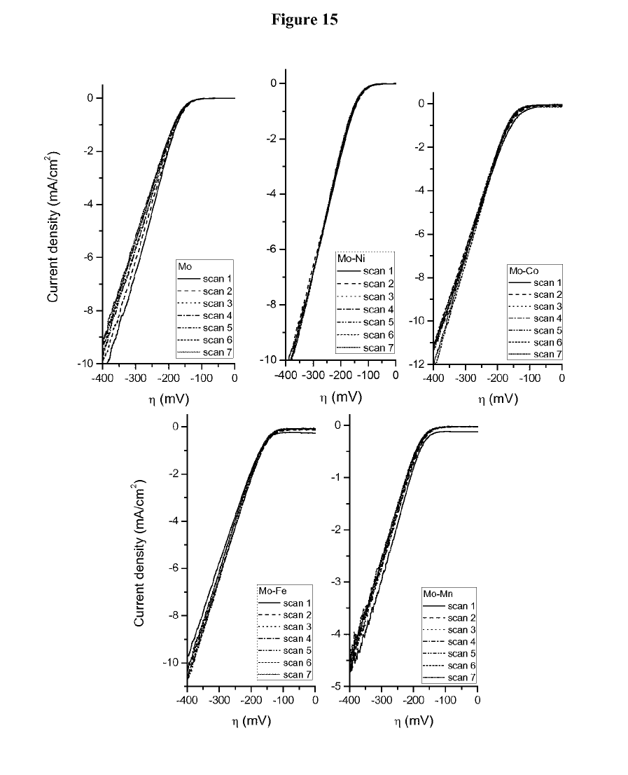

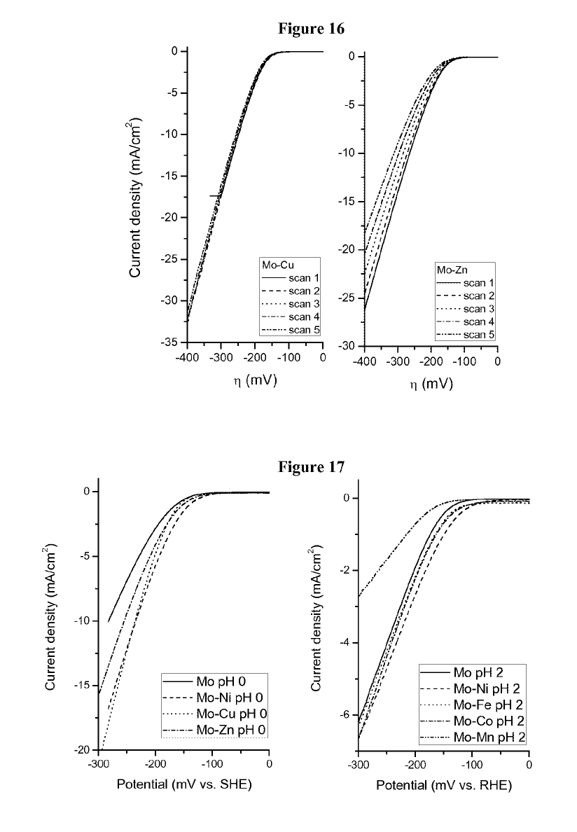

Nearly all films show stable activity—or at least reach stable activity—during consecutive linear sweep measurements in pH 0 or pH 2 buffer solutions (FIGS. 15 and 16). The following statements can be made by comparing the polarization curves of the different films (FIG. 17). ‘Mo—Ni’ is the most active catalyst for proton reduction; at η=200 mV it reveals current densities of 2.7 mA/cm² in pH 2 and 5.7 mA/cm² in pH 0, respectively. ‘Mo’ reaches 1.9 (pH 2) and 2.8 mA/cm² (pH 0) at the same overpotential. Still at η=200 mV, ‘Mo—Fe’ (2.2 mA/cm²; pH 2), ‘Mo—Co’ (2.2 mA/cm²; pH 2), ‘Mo—Zn’ (4.1 mA/cm²; pH 0) and ‘Mo—Cu’ (4.8 mA/cm²; pH 0) show catalytic activities which are in between of those of ‘Mo’ and ‘Mo—Ni’. Even so the activity of ‘Mo—Mn’ seems to be stable, it is low compared to the others (0.7 mA/cm² at η=200 mV; pH 2). It can be concluded that the additional presence of Ni²⁺, Fe²⁺, Co²⁺ or Cu²⁺ in the MoS₄²⁻ deposition solution leads to films with higher catalytic activity for hydrogen evolution. Additional Mn²⁺ leads to a stable but less active film.

### MoSₓ—Ni Films Deposited in Presence of Different Ni²⁺ Concentrations

Similar to the deposition method described above, FTO coated glass plates were modified in a 2 mM solution of (NH₄)₂MoS₄ with different concentrations of NiCl₂ by consecutive cycling voltammetry (22 cycles). The Ni²⁺ concentrations were chosen between 0 and 1 mM. The Tafel slope and the exchange current density (j₀) of each film were determined in 1.0 M H₂SO₄ with a scan rate of 1 mV/s.

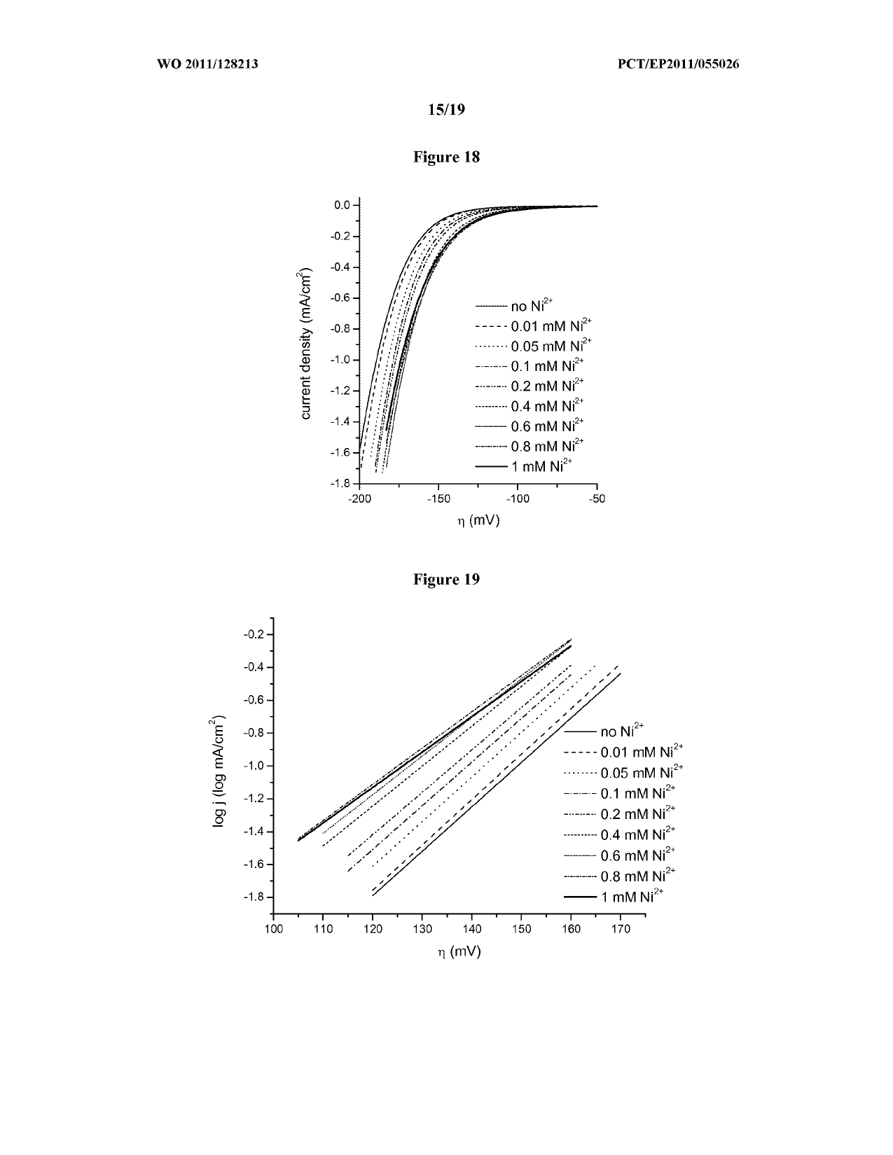

The best film in terms of exchange current density (table 1) is the one deposited in presence of 1 mM Ni²⁺ (1.91 10⁻⁴ mA/cm²). However, at higher overpotentials (η>160 mV) the film deposited in presence of only 0.6 mM Ni²⁺ reveals higher current densities than all other films (FIGS. 18 and 19).

TABLE 1
Tafel slopes and exchange current densities of films deposited in presence
of different Ni²⁺ concentrations:

| | slope | |
|---|---|---|
| | (mV per decade) | j₀ (mA/cm²) |
| no Ni²⁺ | 36.9 | 9.15 · 10⁻⁶ |
| 0.01 mM Ni²⁺ | 36.2 | 8.44 · 10⁻⁶ |
| 0.05 mM Ni²⁺ | 36.8 | 1.34 · 10⁻⁵ |
| 0.1 mM Ni²⁺ | 37.6 | 1.99 · 10⁻⁵ |
| 0.2 mM Ni²⁺ | 38.7 | 3.03 · 10⁻⁵ |
| 0.4 mM Ni²⁺ | 41.1 | 6.86 · 10⁻⁵ |
| 0.6 mM Ni²⁺ | 42.5 | 1.00 · 10⁻⁴ |
| 0.8 mM Ni²⁺ | 45.3 | 1.73 · 10⁻⁴ |
| 1 mM Ni²⁺ | 46.4 | 1.91 · 10⁻⁴ |

### MoSₓ—Co Films Deposited in Presence of Different Co²⁺ Concentrations

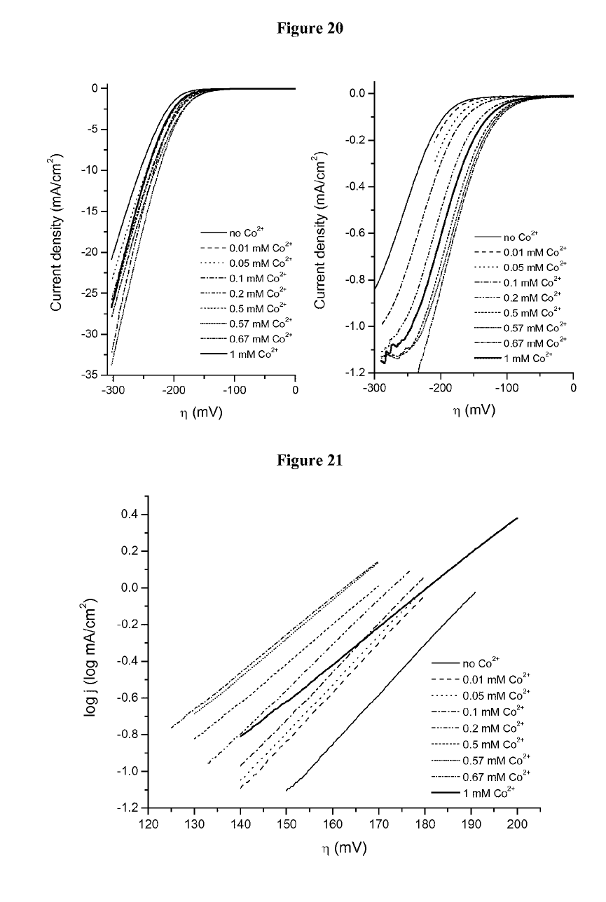

Similar to the deposition method described above, glassy carbon disk electrodes were modified in a 2 mM solution of (NH₄)₂MoS₄ with different concentrations of CoCl₂ by consecutive cycling voltammetry (25 cycles). The Co²⁺ concentrations were chosen between 0 and 1 mM. Polarization curves were measured in pH 0 (1.0 M H₂SO₄) as well as in pH 7 (phosphate buffer) with a scan rate of 1 mV/s. The Tafel slope and the exchange current density (j₀) of each film were determined from the polarization measurements in pH 0. The best film in terms of exchange current density (table 2) is the one deposited in presence of 0.67 mM Co²⁺ (4.82 10⁻⁴ mA/cm²). The same film shows also the highest current densities during polarization measurements in pH 7 (FIG. 20, right). The overpotential in pH 7 is lowered dramatically when Co²⁺ was present during the deposition of the film. As an example, the film deposited in MoS₄²⁻-only solution reveals a current density of −0.5 mA/cm² at η==255 mV, while the film deposited in presence of 0.67 mM Co²⁺ achieves the same current density at η=170. The catalytic activity was also increased in pH 0 when additional Co²⁺ was present during the deposition process of the films (FIGS. 20 and 21).

TABLE 2
Tafel slopes and exchange current densities of films deposited in presence
of different Co²⁺ concentrations:

| | slope | |
|---|---|---|
| | (mV per decade) | j₀ (mA/cm²) |
| no Co²⁺ | 37.1 | 6.94 · 10⁻⁶ |
| 0.01 mM Co²⁺ | 37.6 | 1.51 · 10⁻⁵ |
| 0.05 mM Co²⁺ | 38.0 | 1.83 · 10⁻⁵ |
| 0.1 mM Co²⁺ | 38.3 | 2.32 · 10⁻⁵ |
| 0.2 mM Co²⁺ | 41.2 | 6.37 · 10⁻⁵ |
| 0.5 mM Co²⁺ | 47.4 | 2.65 · 10⁻⁴ |
| 0.57 mM Co²⁺ | 47.7 | 3.82 · 10⁻⁴ |
| 0.67 mM Co²⁺ | 49.0 | 4.82 · 10⁻⁴ |
| 1 mM Co²⁺ | 49.7 | 2.31 · 10⁻⁴ |

### Tungsten Sulphide Films

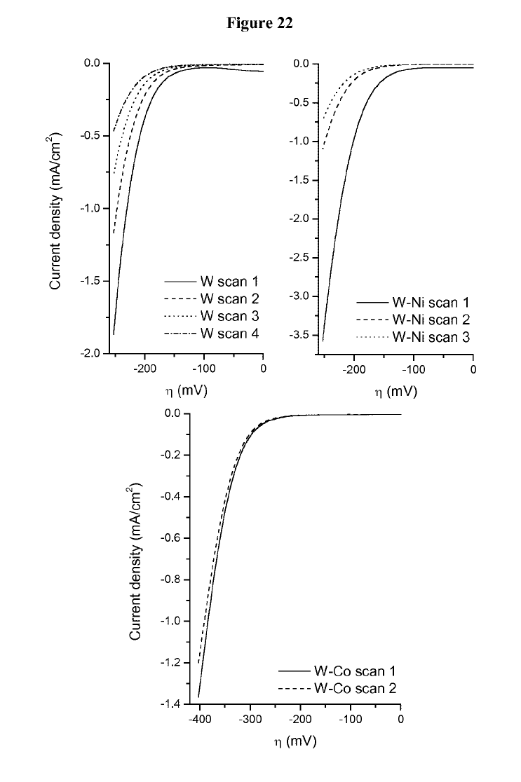

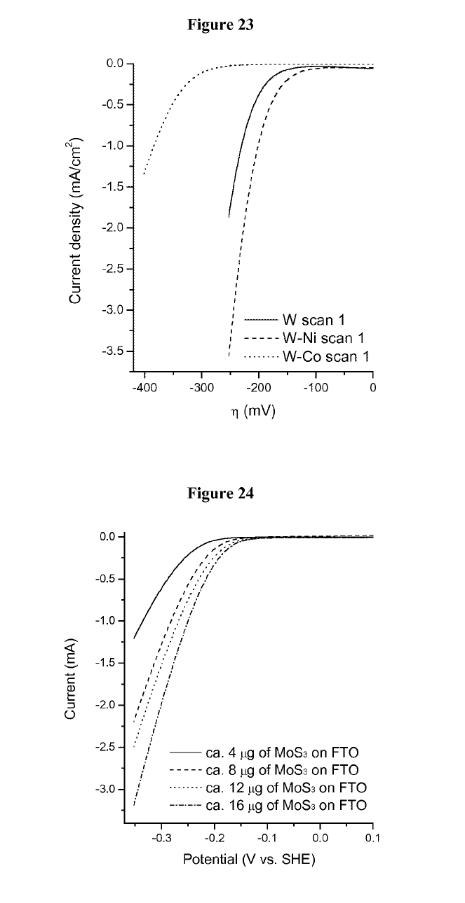

The modification was carried out in a glove box under nitrogen. A 2 mM solution of MCl_{2 (M=Ni or Co) in} 0.1M NaClO₄ (3 ml) was added dropwise to a 4 mM solution of (NH₄)₂WS₄ in 0.1M NaClO₄ (3 ml) under stirring. All chemicals were used as received (Aldrich or Acros). The freshly cleaned FTO coated glass was immersed into the resulting solution. Twenty-two consecutive cyclic voltammograms were carried out on an Ivium Stat potentiostat (Ivium Technologies) with a saturated silver/silver chloride reference electrode (separated by a porous vycor tip) and a titanium wire counter electrode. The cyclic voltammograms were performed between +0.1 and −1.0 V vs. Ag/AgCl (sat.) and a scan rate of 0.05 V/s was employed. Finally, the modified electrode was rinsed with distilled water. The same method was used to deposit a tungsten sulphide film. Therefore, a 2 mM solution of (NH₄)₂WS₄ in 0.1M NaClO₄ was used and no transition metal chloride was added. The tungsten sulphide films show catalytic activity for hydrogen evolution but they are not stable during consecutive linear sweep measurements in pH 0 and their catalytic activity decreases steadily (FIG. 22). Nevertheless, one can discuss the different activities by comparing the first linear sweep scans of each film (FIG. 23). Similar to the molybdenum sulphide films, the presence of additional Ni²⁺ during the deposition leads to a tungsten sulphide film with higher catalytic activity in terms of current density. The onset potential for proton reduction seems to be much higher than those of the ‘W-only’ and ‘W—Ni’ films.

### Amorphous MoS₃ Solid Preparation

In a typical preparation, molybdenum trioxide (1.0 g-6.95 mmol) is dissolved in an aqueous solution of sodium sulphide (8.34 g-34.74 mmol of Na₂S·9H₂O in 250 mL of water) to form a bright yellow solution. This solution is then kept under vigorous stirring while 6.0 molar aqueous HCl is added in a slow rate (˜10 minutes) until the solution reach a pH of 4. At first darkening of the solution is observed and close to the end of the addition large amounts of gaseous H₂S is produced. After the addition of the acid, the solution is boiled for 30 minutes to remove the H₂S present in solution and to improve the filtration step. After being left to cool at ambient temperature the solution is filtered under vacuum and washed copiously with water and then with ethanol. The moist dark paste obtained is then transferred to an Erlenmeyer flask and 1.0 L of acetone is added and the mixture left under stirring for 30 minutes. The suspension obtained is then sonicated for 5 minutes using an ultrasonic horn at 20 kHz. A clear brown sol is obtained and it is stable for at least 3 days without precipitation. If coagulation of the sol is visible it can be sonicated again to yield a clear sol.

The stock MoS₃ sol is used to obtain MoS₃ coated electrodes by simple evaporation of the solvent. The concentration of the sol is around 0.4 g·L⁻¹, determined gravimetrically by weighting the residue of evaporation of 1 mL aliquots. In a general preparation, a drop of the stock solution is added on the conductive surface of FTO coated glass and is then allowed to dry in air. More drops can be added consecutively on the same spot, always letting evaporate the solvent of the previous drop first. FIG. 24 shows polarization curves of electrodes prepared by adding one (4 μg), two (8 μg), three (12 μg) or four (16 μg) drops (ca. 10 μl each) of sol, respectively. It is obvious that the current is higher when more material is present, i.e. when more drops have been added. However, electrodes prepared with a more concentrated sol (1.8 g L⁻¹) showed lower catalytic activity in terms of current (not shown). Since the geometric area of the catalyst is difficult to determine the current was not divided by the area and the electrodes could not be compared in terms of current density.

When powdered MoS₃ is desired, the dark paste obtained after filtering is oven dried for 12 h at 80° C. to yield a black vitreous solid that can be powdered with the aid of a mortar. Electrochemical behavior of this powder was studied in carbon paste electrodes, prepared as followed: In a round bottomed flask, it was weighted 4.5 g of powdered synthetic graphite (<20 μm) and 0.5 g of white paraffin wax. To this mixture 15 mL of hot toluene was added and the mixture sonicated in an ultrasonic bath for 5 minutes. The solvent was removed under vacuum to yield a homogeneous conductive graphite powder. This paste is pressed to fill an empty body working electrode and the surface of the paste is polished using a weighting paper. Powdered MoS₃ which was finely powdered using a mortar is then pressed against the soft surface of the carbon paste electrode and dispersed by gently polishing it using weighting paper. Electrolysis was performed in potentiostatic mode (200 mV vs SHE) in 1.0 M H₂SO₄ (pH=0). The system shows a faradaic yield which is calculated by measuring the total pressure change of the system accounting for the production of both O₂ and H₂.

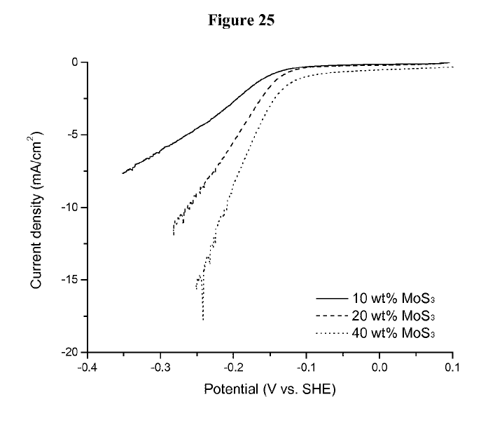

Powdered MoS₃ can be directly added to the conductive graphite powder described above. Using this method, empty body working electrodes were filled with conductive graphite powder containing 10, 20 and 40 wt % of powdered MoS₃, respectively. FIG. 25 shows polarization curves of these electrodes in 1.0 M H₂SO₄. As expected, a higher MoS₃ loading leads to higher catalytic activity. However, to maintain the good conductivity of the paste, the ratio of MoS₃ to graphite should not be too big.

### Preparation of Solids

For example, amorphous MoS₂ solids can be made by a modification of the method already described by Poulomi Roy, Suneel Kumar Srivastava in Thin Solid Films, 496 (2006) 293-298. 20 mL of a 4 mM aqueous solution of (NH₄)₂MoS₄ and 1 mL of hydrazine hydrate (64% N₂H₄ in water) was mixed and heated at 80-90° C. MoS2 solids formed from this reaction. The solids can be put onto a substrate such as FTO and show catalytic activity for hydrogen evolution reaction.

1. Use of amorphous transition metal sulphide films or solids as electrocatalysts for the reduction of proton to form H₂.

2. The use of amorphous transition metal sulphide films or solids of claim 1, wherein the transition metal sulphide is of formula MSₓ, where M is the transition metal and x is in the range 1.5 to 3.5.

3. The use of amorphous transition metal sulphide films or solids of claim 1, wherein the transition metal is selected from the group comprising Mo, W, Fe, Cr, Cu, Ni.

4. The use of amorphous transition metal sulphide films or solids of claim 1, wherein the transition metal sulphide is MoS₂, MoS₃, WS₂ or WS₃.

5. The use of amorphous transition metal sulphide films or solids of claim 1, wherein the amorphous transition metal sulphide films or solids are further doped with at least one metal selected from the group comprising Ni, Co, Mn, Cu, Fe.

6. The use of amorphous transition metal sulphide films or solids of claim 5, wherein the amorphous transition metal sulphide films or solids are further doped with Ni.

7. The use of amorphous transition metal sulphide films or solids of claim 1, wherein H₂ is originated from water or aqueous solutions.

8. An electrode for use in the production of hydrogen gas from water or aqueous solutions comprising an electrode substrate, wherein the amorphous transition metal sulphide films or solids of claim 1 are deposited on said electrode substrate.

9. The electrode of claim 8, wherein the amorphous transition metal sulphide films or solids are selected from the group comprising amorphous MoS₂ film or solid, amorphous MoS₃ film or solid, amorphous WS₂ film or solid, and amorphous WS₃ film or solid.

10. The electrode of claim 8, wherein the electrode substrate is any conducting or semi-conducting substrate, selected from the group comprising glassy carbon disc, reticulated vitreous carbon foam, FTO coated glass, indium tin oxide, carbon fiber, carbon nanotube, carbon clothes, graphene, Si, Cu20, TiO2, titanium metal, and boron-doped diamond.

11. Electrolysers for the hydrolysis of water or aqueous solutions comprising the electrode of claim 8.

12. (canceled)

13. The electrode of claim 8, wherein the amorphous transition metal sulphide films or solids are further doped with at least one metal selected from the group comprising Ni, Co, Mn, Cu, Fe.
